(19) United States
(12) Patent Application Publication
(10) Pub. No.: US 2007/0140439 A1
(43) Pub. Date: Jun. 21, 2007

(54) METHOD FOR PRESENTING LOCATION INFORMATION ON A MOBILE TERMINAL

(76) Inventors: Jakob Olrik, COPENHAGEN O (DK); Christian Kraft, Hvidovre (DK)

Correspondence Address: PERMAN & GREEN, 425 POST ROAD, FAIRFIELD, CT, 06824, US

(21) Appl. No.: 10/538,602

(22) PCT Filed: Dec. 27, 2002
(86) PCT No.: PCT/EP02/14774

§ 371 Date: Oct. 23, 2006

(51) Int. Cl. H04M 1/64

(52) U.S. Cl. 379/67.1

(57) ABSTRACT

The invention relates to handling messages containing landmarks, or landmark related services on a mobile communication terminal. The landmarks are handled by using a message for transmission through a wireless cellular communication network, with a syntax that includes a header part for defining sender/receiver message nature, an identification part for identifying the service, a landmark part for containing location information of one or more objects and a provisioning part for indicating a desired service.

The present invention relates to handling messages containing landmarks, or landmark related services on a mobile communication terminal.

### BACKGROUND ART

Mobile phones have been capable of sending and receiving SMS messages. It has also been possible to receive and send ringing tones, images, profiles and operating settings for the phone, e.g. WAP settings via SMS messages. There has until now however not been provided an effective method for sending landmarks and service requests related to landmarks via SMS.

### DISCLOSURE OF THE INVENTION

On this background, it is an object of the present invention to provide a message for transmission through a wireless cellular communication network in a format that allows of landmarks and service to be transmitted via communication channel of said network. This object is achieved by providing a message for transmission through a wireless cellular communication network, with a syntax that comprises:
a header part for defining sender/receiver message nature;
an identification part for identifying the service;
a landmark part for containing location information of one or more objects; and
a provisioning part for indicating a desired service.

The header part preferably has a message-type section comprising:
a message-keyword field for indicating a message from mobile phone to server or from server to mobile phone;
a request-keyword for indicating that the message is a request; and
a response-keyword for indicating that the message is a response.

The header part may have a location-type identifier section comprising:
a current-keyword field for indicating the use of the current location of the mobile phone; and/or
a landmark-keyword field for exchanging stored landmarks; and/or
a privacy-keyword field for an application-keyword for accessing network applications; and/or
a provisioning-keyword for indicating the desired services and belonging parameters.

The identification part may comprise:
an origin-MSISDN field for indicating the phone number of the phone or server sending the message; and/or
a target-MSISDN field for indicating the phone number of the destination of the message; and/or
a user-text field for containing free text entered by a user; and/or
a service-name and/or a service-description field for containing a short description of service;
and/or a service-landmark field for indicating the number of landmarks to be provided to the service; and/or
a service-parameter field for indicating the service as defined by provisioning; and/or
a privacy-status field for indicating privacy requests.

The landmark part preferably has a landmark field for indicating the beginning of the objection location indicator, and a coordinate-part comprising:
a coordinate field for storing the coordinates of the object as latitude and longitude, preferably in WGS84 or other suitable format; and/or
a name field for containing the name of the object; and/or
an accuracy field for indicating the coordinate accuracy, a date field for containing date and time of the location determination; and/or
a source field for containing the location source; and/or
a position of MSISDN field for containing the MSISDN associated to the object.

The landmark part may further have a geocode part comprising:
a street-name-field for containing a street name; and/or
a street-number-field for containing a street address number; and/or
a zip-field for containing a zip or postal code; and/or
a town-field for containing a town name; and/or
a state-field for containing a state or province name; and/or
a country-field for containing a country name; and/or
a building-name-field for containing a name of a building; and/or
a building-floor-field for containing a building floor number; and/or
a district-field for containing a name of a district.

The landmark part preferably has an extra-info part comprising:
an URL-field for containing an URL associated to the object; and/or
a bitmap-field for containing an URL of a bitmap associated to the object; and/or
a category-field for containing a category associated to the landmark.

The provisioning part may have an SMSC-part comprising:
an SMSC number field for containing an SMSC phone number; and/or
an APPS number field for containing an apps number to which to send messages to reach LMSC.

The provisioning part preferably has a service-part comprising:
a service-name field for containing a name of a service; and/or
a service-parameter field for containing parameters or subnames of services; and/or
a service-landmark field for containing the number of landmark required for the service; and/or
a service-description field for containing a description of a service.

It is another object of the invention to provide an improved method for handling landmarks on a mobile communication terminal when receiving messages including a landmark. This object is achieved by providing a method for handling landmarks on a mobile communication terminal, said mobile communication terminal having means for receiving messages via a communication channel, an application for handling incoming messages that is capable of detecting messages contain a landmark, and a register for storing landmarks comprising:
reception of a message including at least one landmark from a remote terminal, and storing said at least one landmark in said landmark register.

The landmark is preferably provided with an associated category, comprising saving said landmark under the category concerned in the landmark register.

When the landmark is not provided with an associated category, the method may comprise said mobile communication terminals prompting the user to indicate a category to save the landmark in.

The message may include bookmark information defining the location of a server associated with the landmark concerned, preferably a bookmark defining a server document containing a geographical map of the area of the landmark or an image of the landmark, and preferably comprising said mobile communication terminal providing a shortcut to the received bookmark.

The remote terminal can be a server providing location dependent services, preferably a routing service between at least two landmarks or a service for determining the nearest object in a given category to given landmark and the message contains the retrieved landmarks.

The message may further comprise accuracy information of the landmark concerned.

The landmark is preferably stored as a latitude and a longitude, preferably in accordance with WGS84.

The message may further comprise geocode, preferably in the form of a street name, and/or a street address number, and/or a zip or postal code, and/or a town name, and/or a state or province name, and/or a country name, and/or a name of building, and/or a building floor, and/or a name of a district associated with the landmark concerned.

The communication terminal can allow the user to discard a received message, before or after inspection of landmarks included in the message.

It is another object of the invention to provide an improved method for handling landmarks on a mobile communication terminal when receiving service requests. This object is achieved by providing a method for handling landmarks on a mobile communication terminal, said mobile communication terminal having means for receiving messages via a communication channel, an application for handling incoming messages that is capable of detecting messages that contain a landmark related service request comprising:
reception of a message including at least one landmark related service request from a remote terminal, and said mobile communication terminal prompting the user to grant permission to reply to the request.

The service request can be a request for providing the present landmark of the mobile communication terminal to the remote terminal.

The method may comprise the step of said mobile terminal replying by sending a message with a request denial when the user instructs the mobile communication terminal to deny the request.

The method may further comprise the step of said mobile terminal replying by sending a message including the present landmark of the mobile communication terminal when the user instructs the mobile communication terminal to grant the request, or sending a message including another landmark stored on the mobile communication terminal when the user instructs the mobile communication terminal to do so.

It is another object of the invention to provide an improved method for handling landmarks on a mobile communication terminal when sending messages including a landmark. This object is achieved by providing a method for handling landmarks on a mobile communication terminal for use in a communication network, said mobile communication terminal having a register for storing landmarks, means for creating messages and sending these messages via a communication channel to a remote terminal, and an application for handling outgoing messages that is capable of including a landmark in said messages comprising:
sending a message including at least one of said stored landmarks via a communication channel to a remote terminal.

It is another object of the invention to provide an improved method for handling landmarks on a mobile communication terminal when sending messages including a service request related to a landmark. This object is achieved by providing a method for handling landmarks on a mobile communication terminal for use in a communication network, said mobile communication terminal having a register for storing landmarks, means for creating messages and sending these messages via a communication channel to a remote terminal, and an application for handling outgoing messages that is capable of including a service request related to at least one landmark in said messages comprising:
sending a message including a service request related to at least one landmark via a communication channel to a remote terminal.

When the remote terminal is another mobile communication terminal, said service request can be a request to obtain the position of said other terminal.

The remote terminal can be a server providing location dependent services and said request is a request to search landmarks in a database based on criteria contained in said message, and said request comprises at least one landmark, said criteria preferably comprising a distance criterion and a criterion defining the type of landmark to be retrieved.

The remote terminal can be a server providing location dependent services and said request is a request to provide a route from a first landmark to a second landmark and eventually to further landmarks, and said request comprises at least said first and second landmarks, said message further containing criteria for said route, such as the type of route to be provided, such as a route for pedestrians, a route for cyclists, a route for motorists, or a route using public transport.

The method may comprise the step of the routing service upon receiving said message determining a route between said at least start first landmark and said second landmark and sending a response message containing the data describing the determined route to said mobile communication terminal.

The data describing the determined route may comprises text in a natural language describing the route step by step.

It is another object of the invention to provide an mobile communication terminal that has improved incoming message handling capability. This object is achieved by providing a mobile communication terminal for use in a communication network comprising means for receiving messages via a communication channel, and an application handling incoming messages, wherein said application for handling incoming messages has means for detecting messages that include at least one landmark.

The application for handling received messages preferably has means for saving landmarks in said mobile communication terminal, preferably in a dedicated landmark register.

The means for saving landmarks in said mobile communication terminal may be able to store landmarks with an associated name, and preferably also together with additional information associated with the landmark concerned.

The means for saving landmarks may be capable of categorising landmarks by storing a category name with the landmark concerned, and saving landmarks in different categories.

The application for handling received messages may have means for detecting a service request related to a landmark.

The application for handling received messages may have means for responding to a service request by sending a reply message containing a permission to obtain the present location of the mobile communication terminal or containing at least one location stored in the mobile communication terminal.

The mobile communication terminal may further comprise means for sending messages via a communication channel and an application to create messages including landmarks stored in the mobile phone.

The application to create messages may have means for including a service request related to at least one landmark in the created message.

The application to create messages may have means for including parameters for a service request.

It is another object of the invention to provide a mobile communication terminal that has improved outgoing message handling capability. This object is achieved by providing a mobile communication terminal for use in a communication network, said mobile communication terminal having a register for storing landmarks, means for creating messages and sending these messages via a communication channel to a remote terminal, and an application for handling outgoing messages that is capable of including a landmark in said messages.

Further objects, features, advantages and properties of the message, mobile communication terminals, and methods according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 illustrates a preferred embodiment of a communication terminal according to the invention,

FIG. 2 schematically shows the essential parts of a communication terminal for communication with a cellular network,

FIG. 3 shows a network in which location messages may be transferred according to the invention,

FIG. 4 shows the format of a location message according to the invention,

FIG. 4a shows a messaging routing for a request to get own location,

FIG. 4b shows a messaging sequence for receiving a landmark,

FIG. 4c shows a messaging sequence for sending a landmark,

FIG. 4d shows a messaging sequence for requesting the location of a mobile phone,

FIG. 4e shows a messaging sequence for requesting information from a 3^{rd} party server,

FIG. 5a shows a sequence of displays of a preferred embodiment of the invention for landmark handling, saving, sending, and sending a service request,

FIG. 5b, shows a sequence of displays of a preferred embodiment of the invention for receiving landmarks and handling received landmarks, and FIG. 5c shows a sequence of displays of a preferred embodiment of the invention for landmark handling, saving, and sending a service request.

### DETAILED DESCRIPTION

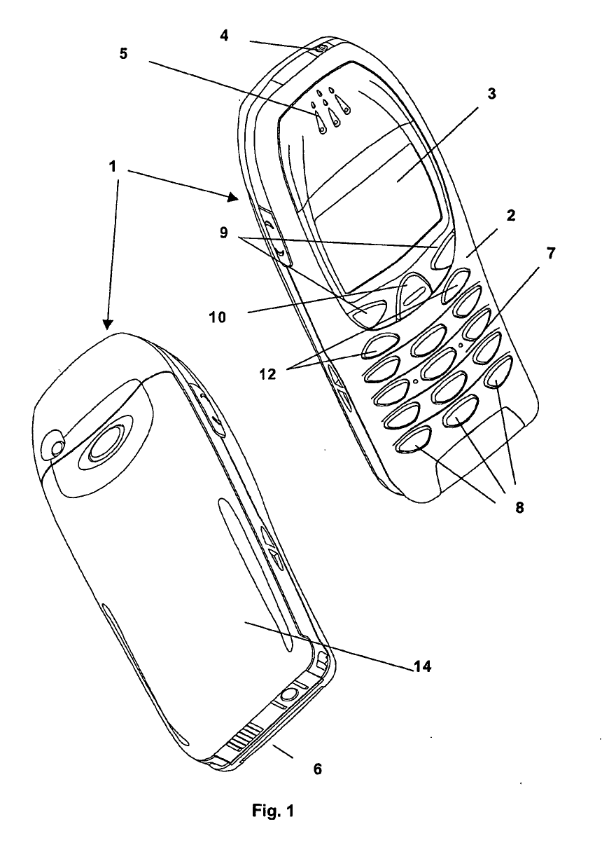

FIG. 1 shows a preferred embodiment of a mobile phone according to the invention, and it will be seen that the phone, which is generally designated by 1, comprises a user interface having a keypad 2, a display 3, an on/off button 4 (present in the top of the phone and therefore not visible in the present view), a speaker 5, and a microphone 6 (openings present in the bottom of the phone and therefore not visible in the present view). The phone 1 according to the preferred embodiment is adapted for communication via a cellular network, such as the GSM 900/1800 MHz network.

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 7 additionally comprises two menu selections or soft-keys 9, two call handling keys 12, and an arrow key 10. The function of the soft-key depends on the state of the phone and the navigation in the menu by using a navigation-key. The present function of the menu selection keys 9 is shown in separate fields in the display 3, just above keys 9. The two call handling keys 12 are used for establishing a call or a conference call, terminating a call or rejecting an incoming call. This key layout is characteristic for e.g. the Nokia 6210™ phone.

The arrow key 10 is an up/down key for cursor movement and scrolling and is placed centrally on the front surface of the phone between the display 3 and the group of alphanumeric keys 7. A battery pack 14 is mounted on the back of the phone and supplies electrical power for the electronic components of the mobile phone.

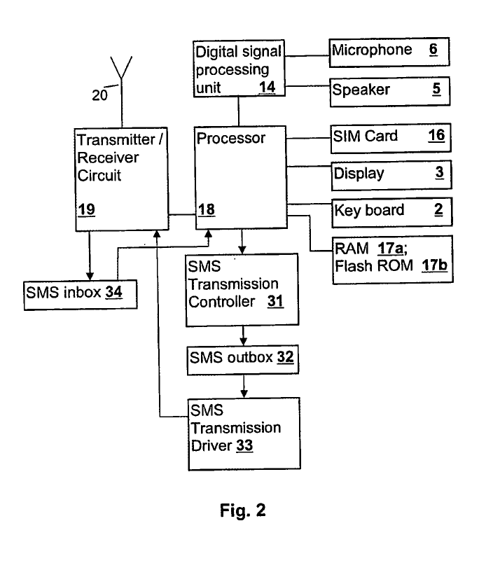

FIG. 2 schematically shows the most important parts of a preferred embodiment of the phone, said parts being essential to the understanding of the invention. The processor 18 controls the communication with the network via the transmitter/receiver circuit 19 and an internal antenna 20.

The microphone 6 transforms the user's speech into analogue signals, the analogue signals formed thereby are A/D converted in an A/D converter (not shown) before the speech is encoded in a digital signal processing unit 14 (DSP). The encoded speech signal is transferred to the processor 18, which i.e. supports the GSM terminal software. The processor 18 also forms the interface to the peripheral units of the apparatus, including a RAM memory 17a and a Flash ROM memory 17b, a SIM card 16, the display 3 and the keypad 2 (as well as data, power supply, etc.). The digital signal-processing unit 14 speech-decodes the signal, which is transferred from the processor 18 to the earpiece 5 via a D/A converter (not shown).

The mobile station main control circuit, includes the processor 18 (can be implemented as several micro-controllers) and blocks 30-33 for controlling transmission of profiles as short messages according to the present invention. The blocks 30-33 can be interpreted as a data processing unit of the terminal, which can be formed in full by programming the processor 18.

In the following, the operation of the terminal will be discussed with focus on the transmission of location messages including a location header part, a location ID part, and landmark part and a provisioning part. The term “landmark” as used here comprises any piece of information holding a unique location and that can be stored in a mobile phone.

By means of the user interface (keyboard 2 and the display 3), the desired landmark is retrieved from the memory. When the user enters a command to send a location message, the processor 18 forms a message in a format set out in detail below.

The processor 18 comprises character transformation functions, which have been implemented as software, and by means of which the processor 18 processes the characters. The processor 18 transfers the line of characters formed to an SMS transmission controller 31, which adds to the message header including message address information, i.e. the information on the destination on the basis of the user input information. The transformation of the location message body and its individual elements into characters is preferably implemented as an application program that is run by the processor 18.

When the address information has been added at the SMS transmission controller 31, the message is transferred into an outbox 32, which sends the message, and which has access to a buffer, in which the message is stored until a successful transmission has been reported. If the transmission fails, the outbox 32 re-transmits the message. When the transmitter/receiver circuit 19 has network coverage and is idle, the message is transferred to an SMS transmission driver circuit 33 by the controller 18 which adds the header to the message information relating to the mobile communications system in question, such as validity information (which indicates in which direction the message is going, i.e. from a mobile station to a message service centre or vice versa), processes the address information into a form required by the mobile communications system (as set out in detail below), and adds to the message the address of the message service centre, as well as the short message identifier, and forms the information to be transmitted, e.g., a digital signal for a transmitter 19.

When a communication terminal 1 receives a location message, the message is received through the transmitter/receiver unit 19 and is passed into a destination box or an inbox 34 of the data processing unit including a memory for storing the message. The received message can be stored in a memory located in the SIM card 16 or in the Ram 17a. First the type of message is detected, and if the received message is an ordinary short message, the processor 18 notifies in the display 3 that short message received.

If the message has an identifier indicating that the message is a location message, the processor 18 will further process the received data.

Network Architecture

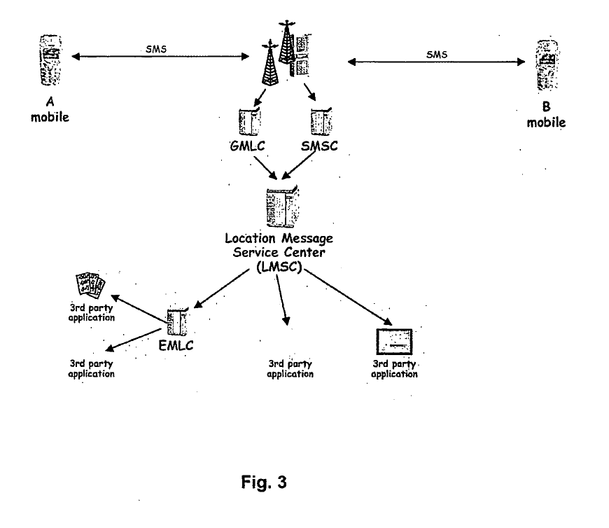

FIG. 3 shows an example of an end to end architecture for location messaging. In the example the network is shown with only two base stations BS and two mobile phones: mobile phone A and mobile phone B, but in reality a network will most likely comprise a great plurality of base stations and an even greater plurality of mobile phones. The base stations of the network are connected to a Short Messaging Services Center (SMSC) that sends and receives SMSes from and to mobile phones and to a Gateway Mobile Location Center (GMLC) that provides a common access point to network entities and external applications for mobile phone location information.

The network further comprises a Location message center LMSC. The LMSC is the network gateway that communicates between the SMSC, the GMLC and mPES or the 3^{rd} party application service providers. The main features of the LMSC are to provide network-based location of the mobiles, OTA provisioning of services in the mobiles and provisioning 3rd party services to be accessed by Location Messaging.

The network further comprises an enabling mobile location center (EMLC) connected to the LMSC and to 3^{rd} party application service providers, processing information about a subscriber's location and providing this information to application service providers (ASPs), while preferably protecting the subscriber's privacy.

All exchanges between mobile phones and gateway are SMS.

Location Message Syntax

The formal grammar of the Location Message is given in the preferred embodiment below using a simple Extended Backus-Naur Form (EBNF) notation, as described at the end of the detailed specification.

The location information format enables location information to be sent to mobile phones. The format enables users of mobile phones to send and receive location messages between mobiles and the LMSC.

Preferably, the data fields are written using Unicode to allow international use. In the mobile phones, the location and landmark application is listening to a port that is dedicated for this purpose, e.g. NBS port 56789 decimal (DDD5 hexadecimal).

The LMSC is accessed via the SMSC through one unique application number. For long SMSes, concatenated short message with 16-bit reference number can be used, as defined in GSM03.40 version 7.4.0.

Syntax

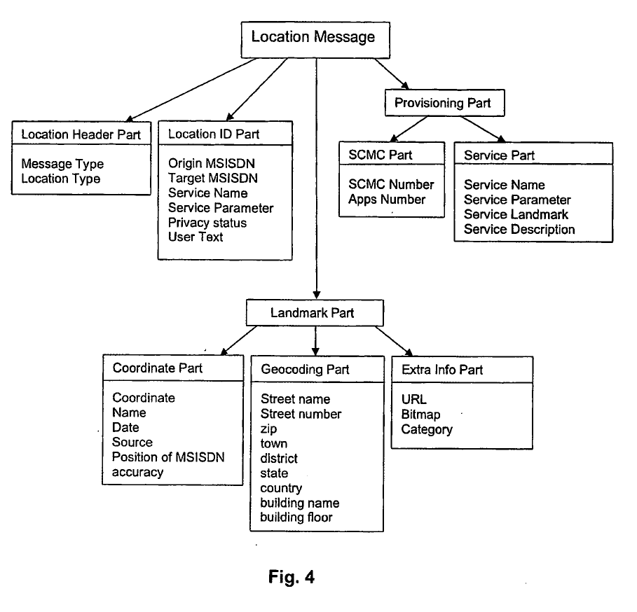

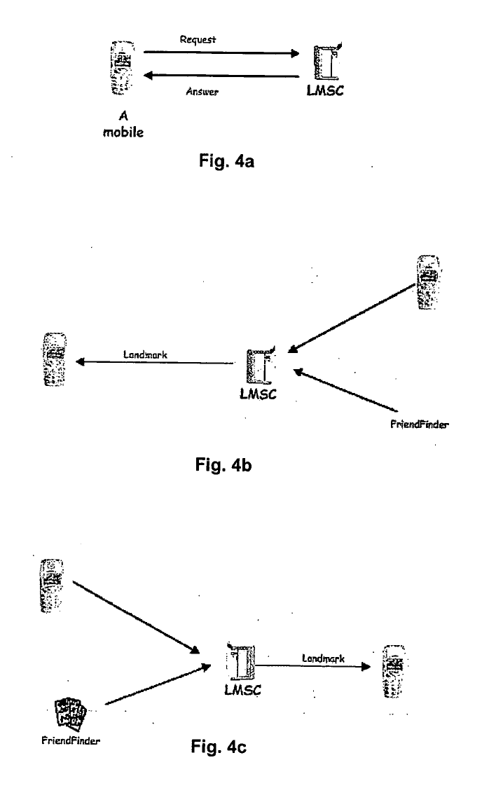

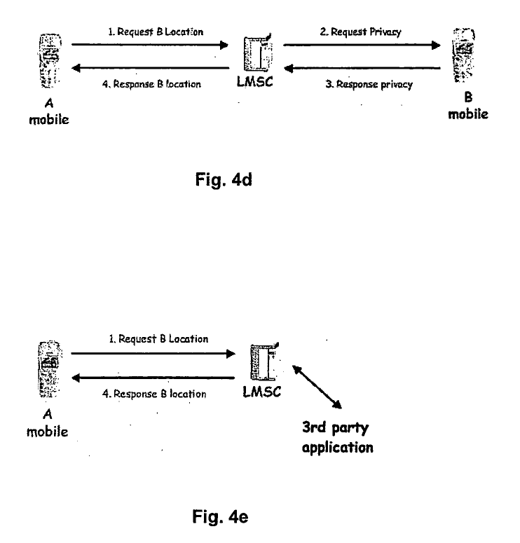

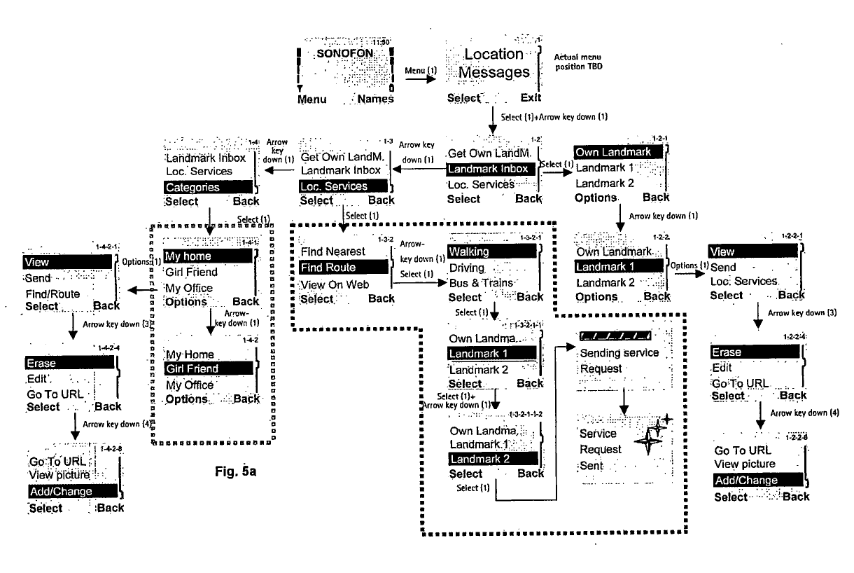

The format uses keywords to separate different data fields. It is divided into modules as can be seen in FIG. 4. The content is in a preferred embodiment formatted as follows:

<location-message>::=

| | |
|---|---|
| <location-header-part> | ; define sender/receiver and message nature |
| <location-id-part> | ; identify service |
| <landmark-part>* | ; information of one or several landmark |
| <provisioning-part>* | ; information of one landmark |

<location-header-part>::= <message-type>“:”<location-type>line-feed>

| <message-type>::= <message-key word> \| <request-keyword> \| <response-keyword> | | |
|---|---|---|
| <message-keyword>::= | 1 | ; ‘message from mobile to mobile or server to mobile’ |
| <request-keyword>::= | 2 | ; ‘request (assumes that response will be given)’ |
| <response-keyword>::= | 3 | ; ‘response to a request’ |
| <location-type>::= | <current-keyword> \| <landmark-keyword> \| <privacy-keyword> \| | |
| | <application-keyword> \| <provisioning-keyword> | |
| <current-keyword>::= | 1 | ; ‘current location of a mobile’ |
| <landmark-keyword>::= | 2 | ; ‘exchanging stored landmarks’ |
| <privacy-keyword>::= | 3 | ; ‘status of privacy settings (permission: yes/no/ . . . )’ |
| <application-keyword>::= | 4 | ; when accessing (request/response) network applications’ |
| <provisioning-keyword::= | 5 | ; ‘services and parameter provisioning |

<location-id-part>::=

| | |
|---|---|
| <origin-msisdn>?, | ; phone or network app sending message |
| <target-msisdn>? | ; final destination of message |
| <user-text>? | ; free text entered by user |
| <service-name>? | ; name of service as defined by provisioning |
| <service-description>? | ; short description of service |
| <service-landmark>? | ; number of landmark to be provided for this service |
| <service-parameter> ? | ; service parameter as defined by provisioning |
| <privacy-status> | ; privacy status for privacy request |

<landmark-part>::=

| | |
|---|---|
| <landmark-field> | ; beginning of landmark indicator |
| <coordinate-part> | ; related to coordinate, acquisition source and date of calculation |
| <geocode-part>? | ; address in text |
| <extra-info-part>? | ; additional info |
| <coordinate-part>::= | |

| | |
|---|---|
| <coordinate> | ; ‘coordinates in WGS84’ |
| <name>? | ; ‘name of the landmark |
| <accuracy>? | ; ‘coordinate accuracy |
| <date> ? | ; ‘date and time of the calculation’ |
| <source>? | ; ‘location source, e.g. gps, network, eotd, map’ |
| <Position of MSISDN>? | ; MSISDN associated to the landmark’ |

<geocode-part>::=

| | |
|---|---|
| <street-name-field>? | ; ‘street name’ |
| <street-number-field>? | ; ‘street address number’ |
| <zip-field>? | ; ‘zip or postal number’ |
| <town-field>? | ; ‘town name’ |
| <state-field>? | ; ‘state or province name’ |
| <country-field>? | ; ‘country name’ |
| <building-name-field>? | ; ‘Name of the building’ |
| <building-floor-field>? | ; ‘Building floor’ |
| <district-field>? | ; ‘Name of the district’ |

<extra-info-part>::=

| | |
|---|---|
| <url-field>? | ; ‘URL associated to the landmark’ |
| <bitmap-field>? | ; URL of bitmap associated to the landmark’ |
| <category-field>? | ; ‘category associated to the landmark’ |

<provisioning-part>::=

| | |
|---|---|
| <SMSC-field>? | ; SMSC number and apps number |
| <service-part>+ | ; service definition |
| <SMSC-part>::= | |

| | |
|---|---|
| <SMSC number> | ; SMSC phone number |
| <apps number>? | ; apps number to which send messages to reach LMSC |

<service-part>::=

| | |
|---|---|
| <Service-name> | ; name of service. |
| <service-parameter>* | ; parameters or subnames of services |
| <service-landmark> | ; number of landmark requested for the service |
| <service-description>* | ; optional description of the service |

| <latitude-field>::= | | {“N”\|“S”} <common-digit>+[“.”<common- |
|---|---|---|
| | | digit>+][“.”<common-digit>+][“.”<common-digit>*] |
| <longitude-field>::= | | {“W”\|“E”} <common-digit>+[“.”<common- |
| | | digit>+][“.”<common-digit>+][“.”<common-digit>*] |
| <altitude-field>::= | | <common-digit>* |
| <accuracy-field>::= | ac: | <default-char-not-if>*<line-feed> |
| <bitmap-field>::= | bl: | <default-char-not-if>*<line-feed> |
| <building-floor-field>::= | bf: | <default-char-not-if>*<line-feed> |
| <building-name-field>::= | bn: | <default-char-not-if>*<line-feed> |
| <catgoryy-field>::= | ca: | <default-char-not-if>*<line-feed> |
| <country-field>::= | cn: | <default-char-not-if>*<line-feed> |
| <coordinate-field>::= | co: | <latitude-fleld><space>+<longitude-field>[<space>+“A” |
| | | <altitude-field>]<line-feed> |
| <date-field>::= | da: | <common-date><line-feed> |
| <district-field>::= | dt: | <default-char-not-if>+<line-feed> |
| <landmark-field>::= | lm: | <line-feed> |
| <name-field>::= | na: | <default-char-not-if>+<line-feed> |
| <street-number-field>::= | nu: | <default-char-not-if>+<line-feed> |
| <origin-msisdn-field>::= | om: | <common-phone-number><line-feed> |
| <position-of-msisdn-field>::= | pm: | <common-phone-number><line-feed> |
| <privacy-status-field>::= | ps: | <No>\|<Yes>\|<default-char-not-if>*<line-feed> |
| <service-description>::= | sd: | <default-char-not-if>+<line-feed> |
| <state-field>::= | se: | <default-char-not-if>+<line-feed> |
| <service-landmark-field>::= | sl: | <default-number-if>+<line-feed> |
| <service-name-fleld>::= | sn: | <default-char-not-if>+<line-feed> |
| <source-field>::=; | so: | <default-char-not-if>+<line-feed> |
| <service-parameter-field>::= | sp: | <default-char-not-if>+<line-feed> |
| <street-name-field> | st: | <default-char-not-if>+<line-feed> |
| <target-msisdn-field>::= | tm: | <common-phone-number><line-feed> |
| <town-field>::= | to: | <default-char-not-if>+<line-feed> |
| <url-field>::= | ur: | <default-char-not-if>+<line-feed> |
| <user-text-field>::= | ut: | <default-char-not-if>+<line-feed> |
| <zip-field>::= | zi: | <default-char-not-if>+<line-feed> |

Additional Information on Fields

<message-type> states the message type. Request and response are used in pairs; response type is used when responding to a request message. Service is used to indicate that the message contains information for provisioning, like service description for inclusion in the dynamic service menu of the terminal. Message is used to send information from phone to phone, without initial request

<origin-MSISDN-field> is used for identifying the origin sender, when a message is relayed by LMSC. It is not part of MO messages.

<target-MSISDN-field> is used for identifying the mobile destination. When the message is relayed by a LMSC, it allows to determine to whom to send the message.

<service-name-field> is used in application message type to convey the application identifier to the application in the terminal to trap the application messages and to deliver them to the correct application.

<service-parameter-field> is optionally used with <service-name-field> to provide parameters to service. For instance, Route service could have driving or walking as parameters.

<service-landmark-field> is used in OTA provisioning to define how many landmarks are required before making request to the service.

<user-text-field> is free text field that the user may fill in.

<landmark-field> is used to convey a known unique coordinate. This coordinate has been computed previously and sent to the mobile.

<latitude-field> and <longitude-field> are the coordinates in WGS84. Leading zero are optionals, minutes, seconds and tens of seconds are optionals.

<altitude-field> is in meters.

<accuracy-field> is used to describe the accuracy of the coordinate values in meters, not including altitude.

The term “geocoding” as used here comprises the cross-referencing between specifically recorded x,y co-ordinates of a location, relative to a standard reference grid such as the UK's National Grid, and non-geographic data such as addresses or post-codes to create geocode. In this way, the accessing of the non-geographic data allows locations to be accurately mapped.

<category-field> is used to classify a landmark as a hotel, a restaurant, a house, or a person. It can be used when displaying a landmark on a map.

<bitmap-field> is a URL that holds a bitmap associated to the particular landmark. It can be displayed by the phone by opening a WEB connection.

<position-of-MSISDN-field> is used to represent the current location of a specified mobile. This requests the LMSC to retrieve the location of the specified mobile, and update the landmark.

Privacy Management

To insure maximum level of privacy, following privacy mechanisms can be implemented:

When current location message is received by a mobile phone, the mobile phone displays who is the originator and which application is involved if any. The user has always the choice to accept or deny its location to be given. Additionally, the user can answer by providing a landmark already stored in the phone.

Request current location is always initiated by the LMSC. It is possible for the mobile to check from SMS header that initiator of the message is same as application number of LMSC.

When LMSC implements network based user privacy rules, it is possible for the user to define which user or application will always be granted or denied access to current location.

Message Scenarios

By way of example, several types of messages transmitted between mobiles and LMSC are described below. Only the mandatory fields have been described for clarity reasons.

Initial Provisioning of the Mobile

This message is sent by the LMSC to provision all parameters needed by the mobile to make use of Location Messaging:
Parameters to access the LMSC
List of available services

An example of a provisioning message is as following:

| Mandatory fields | Description |
|---|---|
| 1:5 | Message/Provisioning |
| smsc: +34609048112 | SMSC number where to send message |
| apn: 007 | Application number to access |
| | Location Messages server |
| sn: nearest | Service name |
| sl: 1 | Number of landmark requested |
| sp: pub | Service parameter = service subname |
| sp: restaurant | Same as above |
| sd: Find Nearest Place | Give short description of service |
| sn: Route | Route service |
| sl: 2+ | Needs 2 or more landmarks |
| sp: walking | Route/walking |
| sp: driving | Route/driving |
| sn: weather | Service name without service |
| | parameter parameter |
| sl: 1 | One landmark |

In this example, 3 services are created:
Nearest service can be requested as Nearest Pub or Nearest Restaurant. It requires only one landmark. If a description can be displayed on the phone, it is Find Nearest Place.
Route service can be requested as either Route/walking or route/driving. It requires two or more landmarks.
Weather Service has no parameters. It requires one landmark.

For each service name, the number of landmark to be sent must be specified:

| Number of landmark | Description |
|---|---|
| <number> | This exact number |
| <number>+ | At least number |

Update of Service List

A mobile phone can query the server to provide an update list of services.

Request Message

A request message to be sent by a mobile phone is as follows:

| Mandatory fields | Description |
|---|---|
| 2:5 | Request/Provisioning |

Response Message

A message answered by the LMSC is as followings:

| Mandatory fields | Description |
|---|---|
| 3:5 | Response/Provisioning |
| sn: nearest | Service name |
| sl: 1 | Need only one landmark |
| sp: pub | Service parameter = service subname |
| sp: restaurant | Same as above |
| sd: find nearest place from | Service help: give short |
| landmark | description of service |
| sn: Route | Route service |
| sl: 2+ | Needs 2 or more landmarks |
| sp: walking | Route/walking |
| sp: driving | Route/driving |
| sn: weather | Service name without service |
| | parameter parameter |
| sl: 1 | One landmark |

Get Own Location

With reference to FIG. 4.1 the scenario of a mobile phone requesting its current location is described. The mobile phone sends a location message to the LMSC to get its current location. A location request message to be sent by a mobile phone is as follows:

| Mandatory fields | Description |
|---|---|
| 2:1 | Request/current |

The LMSC sends the following response message to the mobile phone:

| Mandatory fields | Description |
|---|---|
| 3:1 | Response/current |
| om: +35812345678 | Origin MSISDN = A MSISDN |
| lm: | Landmark indicator |
| co: N45.12.34 E 003.12.34 | Coordinate of mobile at request time |
| ln: current | Landmark name example |

For security reasons, it is checked that this message comes from the LMSC, e.g. by checking that SMS originator=application number.

Receiving a Landmark

With reference to FIG. 4.2 the reception of a message containing a landmark is described. This type of message can be received from any source, either mobile or network application, as an answer to a request.

The message is as follows:

| Mandatory Fields | Description |
|---|---|
| 3:2 | Response/landmark |
| lm: | Landmark indicator |
| co: N45.12.34 E 003.12.34 | Coordinate of mobile at request time |
| ln: myHome | Landmark name |

Sending a Landmark

With reference to FIG. 4.3 the sending of an landmark is described. This message is sent by a mobile phone or by a server, to a mobile phone or to a server. It is not an answer to a previous query. It is for instance used for peer-to-peer landmark exchanges, or for an application creating an landmark.

The message is as follows:

| Mandatory fields | Description |
|---|---|
| 1:2 | Message/landmark |
| lm: | Landmark indicator |
| co: N45.12.34 E 003.12.34 | Coordinate of landmark |
| ln: myHome | Landmark name |

Requesting the Location of Another Mobile Phone

With reference to FIG. 4d requesting the location of another mobile phone is described. This message is sent by a mobile phone to obtain the current location of another mobile phone. Request is carried out through the network so that network-based access control can be applied. Privacy is handled as described above.

The following message is sent from mobile phone A to the LMSC:

| Mandatory fields | Description |
|---|---|
| 2:1 | Request/current |
| tm: +358503860585 | Target MSISDN = B MSISDN |

The LMSC sends the message below to the target MSISDN. This allows for mandatory privacy checking.

| Mandatory fields | Description |
|---|---|
| 2:3 | Request/privacy |
| om: +4520702649 | Origin MSISDN = A MSISDN |
| tm: +358503860585 | Target MSISDN = B MSISDN |

The reply message from mobile phone B to the LMSC:

Mobile phone B sends the message below to the LMSC if it grants permission to send its location.

| Mandatory fields | Description |
|---|---|
| 3:3 | Response/privacy |
| tm: +4520702649 | Target MSISDN = A MSISDN |
| ps: yes | Privacy status: allow to be located |

If mobile phone B does not grant permission to send its location, it will send following message to the LMSC:

| Mandatory fields | Description |
|---|---|
| 3:3 | Response/privacy |
| tm: +4520702649 | Target MSISDN = A MSISDN |
| ps: no | Privacy status: allow to be located |

If mobile phone B does not reply within a given period of time, the LMSC will interpret this event as a denial to provide its location.

The user of mobile phone B may not wish to answer its current location, but with another location stored in the mobile phone. In this case the following reply message is sent:

| Mandatory Fields | Description |
|---|---|
| 3:3 | Response/privacy |
| tm: +4520702649 | Target MSISDN = A MSISDN |
| lm: | Landmark indicator |
| co: N45.12.34 E 003.12.34 | Coordinate of mobile at request time |
| ln: myHome | Landmark name |

Upon receipt of the reply message from mobile phone B, or upon a timeout, the LMSC sends, depending on the type of reply from mobile phone B, one of the following messages:

If mobile phone B denies to be located, the message below is sent:

| Mandatory fields | Description |
|---|---|
| 3:1 | Response/privacy |
| om: +358503860585 | Origin MSISDN = B MSISDN |
| ps: no | Privacy status: allow to be located |

If mobile phone B grants permission to be located, the LMSC computes the location of mobile phone B and sends following message to mobile phone A:

| Mandatory fields | Description |
|---|---|
| 3:1 | Response/privacy |
| om: +358503860585 | Origin MSISDN = B MSISDN |
| ps: yes | Privacy status is ok |
| lm: | Landmark indicator |
| co: N12.34.56 E 001.02.03 | Coordinate of mobile at request time |
| ln : current | Landmark name |

In case mobile phone B has provided a landmark inside Response/Privacy, this landmark is forwarded to mobile phone A. There is no format difference with previous case, so that mobile phone A does not know if the received location this is the real location of mobile phone B of a previously stored location:

| Mandatory fields | Description |
|---|---|
| 3:1 | Response/current |
| om: +358503860585 | Origin MSISDN = B MSISDN |
| ps: yes | Privacy status is OK |
| lm: | Landmark indicator |
| co: N45.12.34 E 003.12.34 | Coordinate of mobile at request time |
| ln: myHome | Landmark name |

For security reasons, it is checked that this message comes from the LMSC, e.g. SMS originator=application number.

Request Information Based on One or Several Landmarks Stored in Phone

With reference to FIG. 4e requesting information based on one or several landmarks, stored in phone (in this example based on the mobile phones own location) from a 3^{rd} party server is described. Hereto, a message is sent by a mobile phone to access services connected behind the LMSC.

The mobile phone sends a request message shown below to the LMSC:

| Mandatory fields | Description |
|---|---|
| 2:4 | Request/application |
| sn: nearest | Service name |
| sp: pub | Service parameter |
| lm: | Landmark indicator |
| co: N45.12.34 E 003.12.34 | Coordinate of mobile at request time |
| ln: myHome | Landmark name |

Several landmarks can be included in the request:

| Mandatory fields | Description |
|---|---|
| 2:4 | Request/application |
| lm: | Landmark indicator |
| co: N45.12.34 E 003.12.34 | Coordinate of mobile |
| ln: myHome | Landmark name |
| lm: | Landmark indicator |
| co: N45.12.34 E 003.12.34 | Coordinate of mobile at request time |
| ln: myOffice | Landmark name |

To include current location in the request, the field pm: can be used. Following examples shows how to request nearest pub from current location of +4520702649:

| Mandatory fields | Description |
|---|---|
| 2:4 | Request/application |
| sn: nearest | Service name |
| sp: pub | Service parameter |
| lm: | Landmark indicator |
| co: N45.12.34 E 003.12.34 | old coordinate of Jakob's mobile |
| ln: Jakob phone | Landmark name |
| pm: +4520702649 | Position of a mobile |

The LMSC wraps the SMS message in XML and sends it to the 3^{rd} party application.

Response Message

Upon receipt of the wrapped SMS request message the 3^{rd} party application processes the request and sends a response message (an SMS wrapped in XML) back to the LMSC. The reply can either be a standard SMS or a location message.

When the 3^{rd} party server uses a location message to reply, the response is sent as follows:

| Mandatory fields | Description |
|---|---|
| 3:4 | Response/application |
| sn: nearest | Service name |
| sp: pub | Service parameter |
| lm: | Landmark indicator |
| co: N45.12.34 E003.12.34 | Landmark coordinate |
| ln: Joe's bar | Landmark name |

Several landmarks can be included in same message:

| Mandatory fields | Description |
|---|---|
| 3:4 | Response/application |
| sn: nearest | Service name |
| sp: pub | Service parameter |
| lm: | Landmark indicator |
| co: N45.12.34 E003.12.34 | Landmark coordinate |
| ln: Joe's bar | Landmark name |
| lm: | Landmark indicator |
| co: N45.34.56 E003.45.67 | Landmark coordinate |
| ln: Coyote's bar | Landmark name |

The LMSC unwraps the response message and sends it to the mobile phone.

User Interface

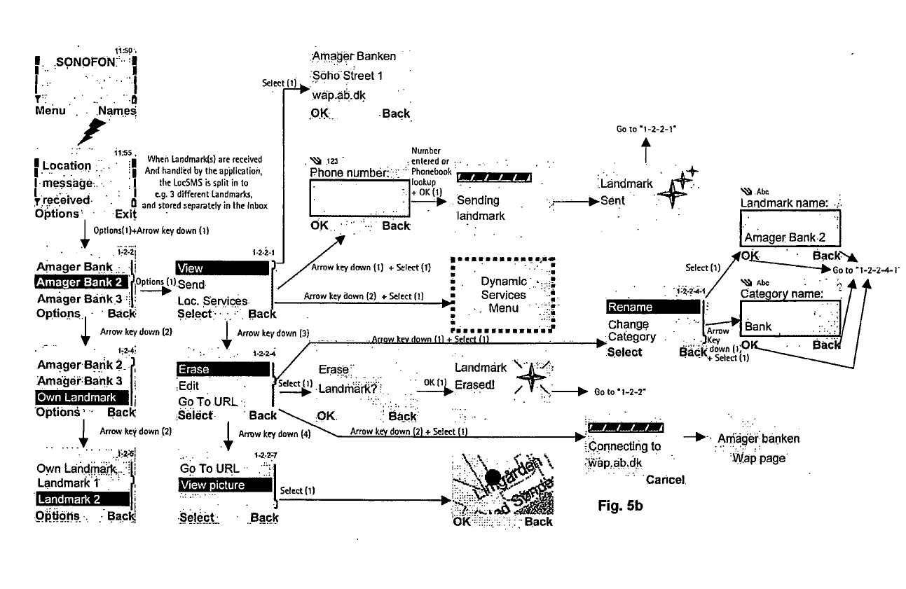

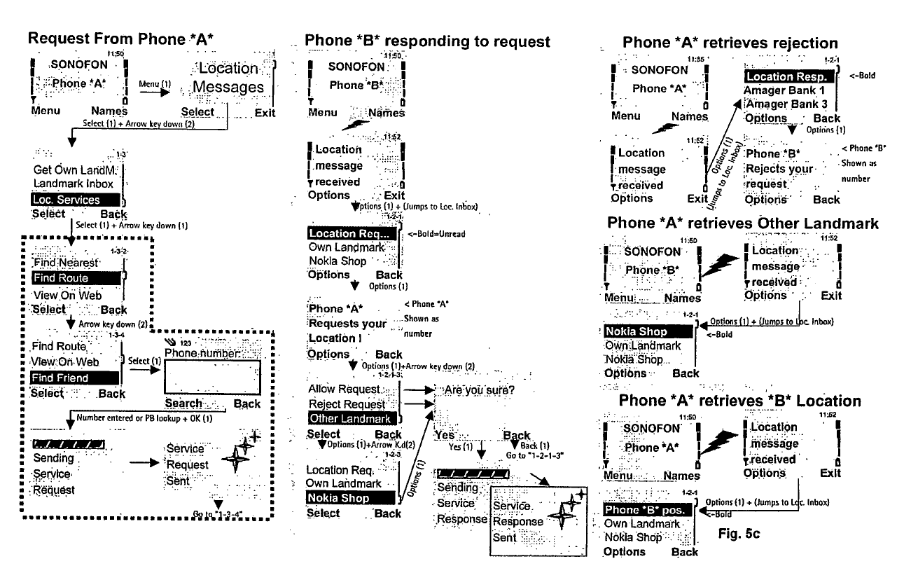

With reference to FIGS. 5a, 5b and 5c a preferred embodiment of the user interface of a mobile phone according to the invention is described. FIGS. 5a, 5b and 5c show displays of the mobile phone in a flowchart style.

The first display of FIG. 5a shows the idle state display (idle status is the home state of the phone in which it is waiting for any input from a user or a network), of a preferred embodiment of the invention. The display 3 includes an operator logo and two softkey labels. By pressing the left softkey 9 “Menu” one item of a scrollable list of selectable menu items is displayed. This list includes commonly used functions such as “Location messages”, “Call register”, “Settings”, “profiles”, “Calendar”, “Services”, etc. In the present embodiment, the “Location messages” menu item is listed first and pressing the left softkey 9 “Select” and then pressing the arrow key 10 down once, opens the location messages menu. The location messages menu comprises a scrollable list with menu items “Get own location”, “Landmark inbox” and “Location services”. The “Landmark inbox” is highlighted and pressing left softkey 9 “Select” opens the landmark inbox.

The landmark inbox, lists the landmarks stored on the phone as a scrollable list from which a landmark may be highlighted using the arrow key 10. By pressing the left softkey 9 “Options” a list of options is displayed including “View”, “Send”, “Loc. Services”, “Erase”, “Edit”, “Go To URL”, “View picture” and Add/Change. Using the arrow key 10 and the left softkey 9 “Select” a user can choose any of these functions related to the landmark.

By pressing the arrow key 10 down twice and pressing the left softkey 9 “Select” in the location messages menu the “Loc. Services” menu is opened. The display lists the location services menu items as a scrollable list including “Find Nearest”, “Find Route”, and “View On Web”. By pressing the arrow key 10 down once and pressing the left softkey 9 “Select” the ‘route finding’ menu items “Walking”, “Driving”, and “Bus & Trains” are displayed with the first item of the list “Walking” highlighted by the cursor. Pressing the left softkey “Select” attaches the “Walking” parameter to the service request, so that the server that provides the route is aware that the route should be of a type suitable for pedestrians, and brings the mobile phone to the next state in which the display lists the landmarks stored in the mobile phone for attaching to the service request: “Own landmark”, “Landmark 1” and “Landmark 2” with “Landmark 1” highlighted by the cursor. By pressing the arrow key 10 down once and pressing the left softkey 9 “Select”, landmark 1 is attached to the service request. The same procedure is applied to attach landmark 2 to the message. Then the processor 18 creates a message in the format described above and sends it to the remote server. The display first shows the text “Sending service request” and animation of the transfer of the message and then a message “Service request sent” when the transfer of the message is complete.

Pressing the arrow key 10 down three times after entering the location messages menu highlights the menu item “Categories”, which is in fact the access to the register of stored landmarks. By pressing the left softkey 9 “Select”, the categories menu items are listed as a scrollable list of menu items with “My home” highlighted by the cursor. Using the arrow key 10 up or down allows highlighting of any stored landmark on the list. By pressing the left softkey 9 “Options” a scrollable list of menu items for the highlighted landmark is displayed with the menu item “View” highlighted by the cursor. By pressing the arrow key 10 up or down the other menu items “Edit”, “Go To URL”, “View picture” and “Add/Change” can be highlighted for selection with the left softkey 9.

The reception of landmarks is described with reference to FIG. 5b. Upon receipt of a location message the idle menu changes to display the text “Location message received”, and the left softkey 9 changes to “Options” and the right softkey 9 changes to “Exit”. If more than one landmark is included in the message the application splits the location message in a corresponding number of messages and saves them in the landmark inbox. By pressing the left softkey 9 “Options”, the location message inbox is opened and the newly received locations are listed above previously received messaged and a first of the newly received messages being highlighted by a cursor, and the newly received landmark being shown in bold print to indicate that they have not been read. By pressing the arrow key one of the landmarks can be highlighted and by pressing the left softkey 9 “Options” a list of options menu items is displayed comprising “View”, “Send”, “Loc. Services”, “Erase”, “Edit”, “Go To URL”, and “View picture”.

By pressing the left softkey 9 “Select” in the options menu, the retrieved landmark is displayed by showing a text with the latitude and longitude of or the geocoordinates as shown by way of example in FIG. 5b as: “Amanger Banken, Soho Street 1, wap.ab.dk”.

By pressing the arrow key down once and pressing the left softkey 9 “Select” form the start in the options menu, the mobile phone prompts the user to enter a phone number to send the landmark too. The display changes to show a box for entering a phone number or alternatively, a phone number can be looked up in the phonebook. When the phone number has been entered or selected the message can be send by pressing the left softkey 9 “OK”. The display first shows a text “Sending landmark” and animation of the transfer of the message and then a message “Landmark sent” when the transfer of the message is completed.

By pressing the arrow key down twice from the start in the options menu and pressing the left softkey 9 “Select”, the “Loc. service” item from the list of menu items is highlighted and by pressing the softkey 9 “Select” the location services menu is entered.

By pressing the arrow key down three times from the start in the options menu and pressing the left softkey 9 “Select”, the “Edit” item from the list of menu items is highlighted and by pressing the softkey 9 “Select” the menu items of the edit submenu “Rename”, “Change”, and “Category are listed. Selecting “Rename” opens a text editing box that prompts the user to enter a new name for the landmark concerned using the alphanumerical keypad. Selecting “Category” opens a text editing box that prompts the user to enter a category for the landmark concerned using the alphanumerical keypad.

By pressing the arrow key down four times from the start in the options menu and pressing the left softkey 9 “Select”, the “Erase” item from the list of menu items is highlighted and by pressing the softkey 9 “Select” a confirmation text “Erase Landmark?” is displayed. By pressing the softkey 9 “OK” the landmark is erased and the text “Landmark erased” is displayed.

By pressing the arrow key down five times from the start in the options menu and pressing the left softkey 9 “Select”, the “Go To URL” item from the list of menu items is highlighted and by pressing the softkey 9 “Select” a confirmation text “Connecting to URL” is displayed (the URL in FIG. 5b is shown by way of example as: wap.ab.dk). When the web page has been fetched it is shown on the display.

By pressing the arrow key down six times from the start in the options menu and pressing the left softkey 9 “Select”, the “View picture” item form the list of menu items is highlighted and by pressing the softkey 9 “Select” the picture attached to the landmark is shown. In FIG. 5 the picture shown is a street map of the area around the landmark by way of example.

A request of a mobile phone A to obtain the position (landmark) of mobile phone B is described with reference to FIG. 5c. By pressing the left softkey 9 “Menu” the “Location Messages” menu is displayed. By pressing softkey 9 “Select”, and the arrow key 10 down twice, the location messages menu items are displayed as a scrollable list with the “Loc. Services” menu item highlighted by the cursor. By pressing the left softkey 9 “Select” and the arrow key 10 down the “Find Route” menu item is highlighted. By pressing the arrow key 10 down twice more, the “Find Friend” menu item is highlighted. By pressing the left softkey 9 “Select” the mobile phone prompts for the user to enter a phone number (MSISDN) of the terminal to be located and displays hereto a box allowing entry of a number using the alphanumeric keys 7. Alternatively, by pressing the left softkey 9 “Search” a menu will be shown in which the stored phone numbers in the phonebook can be searched and selected. When a phone number has been entered or selected from the phone book, the left softkey 9 changes to “OK”. By pressing the left softkey 9 “OK” the messages including the location request is sent to mobile phone B.

When mobile phone B receives the location message with the request, the display changes from the idle menu to show the text “Location message received”. The left softkey 9 has changed to “Options”, and by pressing it, the landmark inbox is opened and the newly received location message being listed first, highlighted by the cursor and in bold print to indicate that it has not yet been read. By pressing softkey 9 “Options” the phone displays the request: “Phone A Requests you Location!”. By pressing left softkey 9 “Options” and the arrow key 10 down twice the options menu items “Allow request”, “Reject request” and “Other landmark” are displayed, with the menu item “Other Landmark” is highlighted. By pressing the left softkey 9 “Select”, the landmark register with stored landmarks is opened and using arrow key 10 a landmark can be highlighted, and by pressing left softkey 9 “Select” a confirmation display with the text “Are you sure?” is displayed. By pressing left softkey 9 “Yes”, the message is sent and the display shows the text “Sending Service Response”. When the message has been sent the display shows a confirmation text “Service Response Send”.

The user can allow the request, or reject the request by highlighting and selecting the corresponding menu item.

When mobile phone A retrieves a rejection, the display changes from the idle menu to display the message “Location message received”. The left softkey 9 has changed to “Options” and by pressing it the landmark inbox is opened and the newly received location message is listed first, highlighted by the cursor and in bold print to indicate that it has not yet been read. By pressing softkey 9 “Options” the phone displays the rejection: “Phone B rejects your request”, whereby mobile phone B is shown as a phone number (MSISN), or if the phone number is stored in the phonebook by the name associated to the stored phone number.

When mobile phone A retrieves an other landmark the display changes from the idle menu to display the message “Location message received”. The left softkey 9 has changed to “Options” and by pressing it the landmark register is opened. The landmark register lists the newly received location first, highlighted by the cursor. Pressing left key 9 “Options” enables access to all information related to the received landmark.

When mobile phone A retrieves the location of mobile phone B display changes from the idle menu to display the message “Location message received”. The left softkey 9 has changed to “Options” and by pressing it the landmark inbox is opened and the newly received location message is listed first, highlighted by the cursor. Pressing the left key 9 “Options” enables access to all information related to the received landmark.

EBNF Notation

The formal grammar of Location is given in this specification using a simple Extended Backus-Naur Form EBNF) notation. Each rule in the grammar defines one symbol, in the form

symbol ::=expression

Symbols are written with an initial capital letter if they are the start symbol of a regular language, otherwise with an initial lower case letter. Literal strings are quoted.

Within the expression on the right-hand side of a rule, the following expressions are used to match strings of one or more characters:

#xN

where N is a hexadecimal integer, the expression matches the character in ISO/IEC 10646 whose canonical (UCS-4) code value, when interpreted as an unsigned binary number, has the value indicated. The number of leading zeros in the #xN form is insignificant; the number of leading zeros in the corresponding code value is governed by the character encoding in use and is not significant for Location Message.

[a-zA-Z], [#xN-#xN]

matches any char with a value in the range(s) indicated (inclusive).

[abc], [#xN#XN#xN]

matches any char with a value among the characters enumerated. Enumerations and ranges can be mixed in one set of brackets.

[ˆa-z], [ˆ#xN-#xN]

matches any char with a value outside the range indicated.

[ˆabc], [ˆ#xN#xN#xN]

matches any char with a value not among the characters given. Enumerations and ranges of forbidden values can be mixed in one set of brackets.

“string”

matches a literal string matching that given inside the double quotes.

‘string’

matches a literal string matching that given inside the single quotes.

These symbols may be combined to match more complex patterns as follows, where A and B represent simple expressions:

(expression)

expression is treated as a unit and may be combined as described in this list.

A?

Although the present invention has been described in detail for purpose of illustration, it is understood that such detail is solely for that purpose, and variations can be made therein by those skilled in the art without departing from the scope of the invention.

Thus, while the preferred embodiments of the devices and methods have been described in reference to the environment in which they were developed, they are merely illustrative of the principles of the inventions. Other embodiments and configurations may be devised without departing from the scope of the appended claims.

1. A message for transmission through a wireless cellular communication network, with a syntax that comprises:
a header part for defining sender/receiver message nature;
an identification part for identifying the service;
a landmark part for containing location information of one or more objects; and
a provisioning part for indicating a desired service.

2. A message according to claim 1, in which the header part has a message-type section comprising:
a message-keyword field for indicating a message from mobile phone to server or from server to mobile phone;
a request-keyword for indicating that the message is a request; and
a response-keyword for indicating that the message is a response.

3. A message according to claim 1, in which the header part has a location-type identifier section comprising:
a current-keyword field for indicating the use of the current location of the mobile phone; and/or
a landmark-keyword field for exchanging stored landmarks; and/or
a privacy-keyword field for an application-keyword for accessing network applications; and/or
a provisioning-keyword for indicating the desired services and belonging parameters.

4. A message according to claim 1, in which the identification part comprises:
an origin-msisdn field for indicating the phone number of the phone or server sending the message; and/or a target-msisdn field for indicating the phone number of the destination of the message; and/or
a user-text field for containing free text entered by a user; and/or
a service-name and/or service-description field for containing a short description of service;
and/or a service-landmark field for indicating the number of landmarks to be provided to the service; and/or
a service-parameter field for indicating the service as defined by provisioning; and/or
a privacy-status field for indicating privacy requests.

5. A message according to claim 1, in which the landmark part has a landmark field for indicating the beginning of the objection location indicator, and a coordinate-part comprising:
a coordinate field for storing the coordinates of the object as latitude and longitude, preferably in WGS84 or other suitable format; and/or
a name field for containing the name of the object; and/or
an accuracy field for indicating the coordinate accuracy, a date field for containing date and time of the location determination; and/or
a source field for containing the location source; and/or
a position of MSISDN field for containing the MSISDN associated to the object.

6. A message according to claim 1, in which the landmark part has a geocode part comprising:
a street-name-field for containing a street name; and/or
a street-number-field for containing a street address number; and/or
a zip-field for containing a zip or postal code; and/or
a town-field for containing a town name; and/or
a state-field for containing a state or province name; and/or
a country-field for containing a country name; and/or
a building-name-field for containing a name of a building; and/or
a building-floor-field for containing a building floor number; and/or
a district-field for containing a name of a district.

7. A message according to claim 1, in which the landmark part has an extra-info part comprising:
an URL-field for containing an URL associated to the object; and/or
a bitmap-field for containing an URL of a bitmap associated to the object; and/or
a category-field for containing a category associated to the landmark.

8. A message according to claim 1, in which the provisioning part has an SMSC-part comprising:
an SMSC number field for containing an SMSC phone number; and/or
an APPS number field for containing an APPS number to which to send messages to reach LMSC.

9. A message according to claim 1, in which the provisioning part has a service-part comprising:
a service-name field for containing a name of a service; and/or
a service-parameter field for containing parameters or subnames of services; and/or
a service-landmark field for containing the number of landmark required for the service; and/or a service-description field for containing a description of a service.

10. A method for handling landmarks on a mobile communication terminal, said mobile communication terminal having means for receiving messages via a communication channel, an application for handling incoming messages that is capable of detecting messages containing a landmark, and a register for storing landmarks comprising:
reception of a message including at least one landmark from a remote terminal, and storing said at least one landmark in said landmark register.

11. A method according to claim 10, in which said at least one landmark is provided with an associated category, comprising saving said landmark under the category concerned in the landmark register.

12. A method according to claim 10, in which said at least one landmark is not provided with an associated category, comprising said mobile communication terminals prompting the user to indicate a category to save the landmark in.

13. A method according to claim 10, in which said message includes bookmark information defining the location of a server associated with the landmark concerned, preferably a bookmark defining a server document containing a geographical map of the area of the landmark or an image of the landmark, and preferably comprising said mobile communication terminal providing a shortcut to the received bookmark.

14. A method according to claim 10, wherein said remote terminal is a server providing location dependent services, preferably a routing service between at least two landmarks or a service for determining the nearest object in a given category to given landmark and the message contains the retrieved landmarks.

15. A method according to claim 10, wherein said message further comprises accuracy information of the landmark concerned.

16. A method according to claim 10, wherein the landmark is stored as a latitude and a longitude, preferably in according with WG84.

17. A method according to claim 10, wherein said message comprises geocode, preferably in the form of a street name, and/or a street address number, and/or a zip or postal code, and/or a town name, and/or a state or province name, and/or a country name, and/or a name of building, and/or a building floor, and/or a name of a district associated with the landmark concerned.

18. A method according to claim 10, wherein the communication terminal allows the user to discard a received message, before of after inspection of landmarks includes in the message.

19. A method according to claim 10, in which the received message has a format in accordance with any of claims 1 to 9.

20. A method for handling landmarks on a mobile communication terminal, said mobile communication terminal having means for received messages via a communication channel, an application for handling incoming messages that is capable of detecting messages that contain a landmark related service request comprising:
reception of a message including at least one landmark related service request from a remote terminal, and said mobile communication terminal prompting the user to grant permission to reply to the request.

21. A method according to claim 20, wherein said service request is a request for providing the present landmark of the mobile communication terminal to the remote terminal.

22. A method according to claim 21, comprising said mobile terminal replying by sending a message with a request denial when the user instructs the mobile communication terminal to deny the request.

23. A method according to claim 21, comprising said mobile terminal replying by sending a message including the present landmark of the mobile communication terminal when the user instructs the mobile communication terminal to grant the request, or sending a message including another landmark stored on the mobile communication terminal when the user instructs the mobile communication terminal to do so.

24. A method according to claim 20, in which the received message has a format in accordance with any of claims 1 to 9.

25. A method for handling landmarks on a mobile communication terminal for use in a communication network, said mobile communication terminal having a register for storing landmarks, means for creating messages and sending these messages via a communication channel to a remote terminal, and an application for handling outgoing messages that is capable of including a landmark in said messages comprising:
sending a message including at least one of said stored landmarks via a communication channel to a remote terminal.

26. A method according claim 25, in which the sent message has a format comprising:
a header part for defining sender/receiver message nature;
an identification part for identifying the service;
a landmark part for containing location information of one or more objects; and
a provisioning part for indicating a desired service.

27. A method for handling landmarks on a mobile communication terminal for use in a communication network, said mobile communication terminal having a register for storing landmarks, means for creating messages and sending these messages via a communication channel to a remote terminal, and an application for handling outgoing messages that is capable of including a service request related to at least one landmark in said messages,
comprising sending a message including a service request related to at least one landmark via a communication channel to a remote terminal.

28. A method according to claim 27, wherein said remote terminal is another mobile communication terminal and said service request is a request to obtain the position of said other terminal.

29. A method according to claim 27, wherein said remote terminal is a server providing location dependent services and said request is a request to search landmarks in a database based on criteria contained is said message, and said request comprises at least one landmark, said criteria preferably comprising a distance criterion and a criterion defining the type of landmark to be retrieved.

30. A method according to claim 29, wherein said remote terminal is a server providing location dependent services and said request is a request to provide a route from a first landmark to a second landmark and eventually to further landmarks, and said request comprises at least said first and second landmarks, said message further containing criteria for said route, such as the type of route to be provided, such as a route for pedestrians, a route for cyclists, a route for motorists, or a route for persons using public transport.

31. A method according to claim 30, comprising said routing service upon receiving said message determining a route between said at least start first landmark and said second landmark and sending a response message containing the data describing the determined route to said mobile communication terminal.

32. A method according to claim 31, in which said data describing the determined route comprises text in a natural language describing the route step by step.

33. A method according to claim 27, in which the sent message has a format comprising:
a header part for defining sender/receiver message nature;
an identification part for identifying the service;
a landmark part for containing location information of one or more objects; and
a provisioning part for indicating a desired service.

34. A mobile communication terminal for use in a communication network comprising means for receiving messages via a communication channel, and an application handling incoming messages, wherein said application for handling incoming messages has means for detecting messages that include at least one landmark.

35. A mobile communication terminal according to claim 34, wherein said application for handling received messages has means for saving landmarks in said mobile communication terminal, preferably in a dedicated landmark register.

36. A mobile communication terminal according to claim 35, wherein said means for saving landmarks in said mobile communication terminal is able to store landmarks with an associated name, and preferably also together with additional information associated with the landmark concerned.

37. A mobile communication terminal according to claim 35, wherein said means for saving landmarks is capable of categorising landmarks by storing a category name with the landmark concerned, and saving landmarks in different categories.

38. A mobile communication terminal according to claim 34, wherein said application for handling received messages has means for detecting a service request related to a landmark.

39. A mobile communication terminal according to claim 34, wherein said application for handling received messages has means for responding to a service request by sending a reply message containing a permission to obtain the present location of the mobile communication terminal or containing at least one location stored in the mobile communication terminal.

40. A mobile communication terminal according to claim 34, further comprising means for sending messages via a communication channel and an application to create messages including landmarks stored in the mobile phone.

41. A mobile communication terminal according to claim 34, wherein said application to create messages has means for including a service request related to at least one landmark in the created message.

42. A mobile communication terminal according to claim 41, wherein said application to create messages has means for including parameters for a service request.

43. A mobile communication terminal for use in a communication network,
said mobile communication terminal having a register for storing landmarks, means for creating messages and sending these messages via a communication channel to a remote terminal, and an application for handling outgoing messages that is capable of including a landmark in said messages.
